(19) United States
(12) Patent Application Publication
(10) Pub. No.: US 2005/0195345 A1
(43) Pub. Date: Sep. 8, 2005

(54) Liquid crystal display

(75) Inventors: Dien-Shen Chiang, Taipei City (TW); Shih-Chang Chang, Hsinchu (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/043,792

(22) Filed: Jan. 25, 2005

(30) Foreign Application Priority Data
Mar. 3, 2004 (TW) 93105496

(51) Int. Cl. G02F 1/1335

(52) U.S. Cl. 349/114

(57) ABSTRACT

A mirror liquid crystal display. A plurality of pixel regions, each includes a transparent region and a non-transparent region. A plurality of mirror electrode layers are formed on the corresponding non-transparent regions, with the mirror electrodes connected with each other. A plurality of transmissive electrode layers on the corresponding transparent regions are isolated from the mirror electrode layers. A voltage is coupled to the mirror electrode layers to control liquid crystals over the non-transparent region.

### BACKGROUND OF THE INVENTION

1. Field of the Invention

The present invention relates to a display and in particular to a mirror liquid crystal display (LCD).

2. Description of the Related Art

Typically, contrast ratio in a transmissive display diminishes in bright environments. Light sources used in reflective displays are ambient light, thus increasing contrast ratio in bright environments. Another advantage of the reflective display is low power consumption. However, it is difficult to provide high quality and high contrast ratio under low ambient lighting conditions.

In the past, mirror liquid crystal displays have been developed. Mirror liquid crystal displays provide a mirror on a transmissive or a reflective display by an optical film or two liquid crystal layers. When the mirror liquid crystal displays are in an off state (i.e., not displaying image data), the displays can be used as mirrors, thus providing certain convenience to the users.

FIG.1 is a cross section of a conventional mirror display. As shown in FIG.1, a liquid crystal layer 14 is interposed between a first substrate 10 and a second substrate 12. A color filter layer 18 and a common electrode layer 20 are disposed on the inner side of the second substrate 12 in sequence. A diffuser 22, λ/4 phase difference film 24, a polarizer 26 and an anti-reflective layer 28 are disposed on the outer side of the second substrate 12 in sequence. A mirror structure 25 comprising a third substrate 25a, fourth substrate 25b and a cholesterol liquid crystal layer 16 therebetween are disposed on the LCD. Disposition of the mirror structure 25 increase thickness of the display in addition to creating high costs.

### SUMMARY OF THE INVENTION

Accordingly, the invention provides a mirror LCD with no requirement for an additional mirror element. The liquid crystals in the mirror region can be controlled during operation by the mirror electrode layer to decrease reflected light and increase contrast ratio.

Accordingly, the present invention provides a display comprising a plurality of pixel regions, each including a transparent region and a non-transparent region. A plurality of mirror electrode layers are formed on the corresponding non-transparent regions, and the mirror electrodes are connected with each other. A plurality of transmissive electrode layers are formed on the corresponding transparent regions and isolated from the mirror electrode layers. Voltage is applied to the mirror electrode layers to control liquid crystals over the non-transparent region.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a sectional view of a conventional mirror display;

FIG. 2 is a sectional view of a mirror LCD panel in accordance with one embodiment of the present invention;

FIG. 3 is a top view of the mirror LCD panel in accordance with one embodiment of the present invention;

FIG. 4A is a cross section along line 4A-4A of FIG.3.

FIG. 4B is a cross section of another embodiment of the invention.

FIG. 5 is a schematic diagram of a display device comprising the mirror LCD panel in accordance with the present invention; and

FIG. 6 is a schematic diagram of an electronic device comprising the mirror display device in accordance with the present invention.

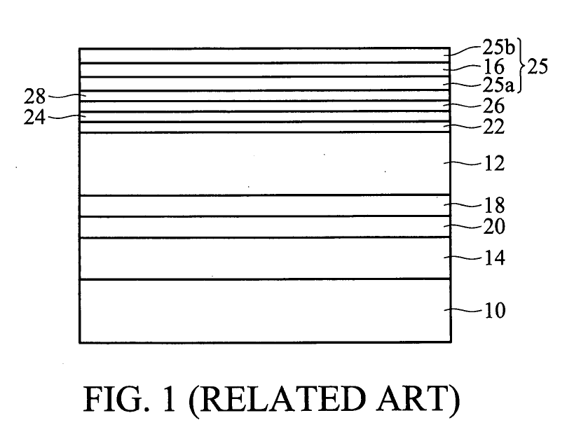

### DETAILED DESCRIPTION OF THE INVENTION

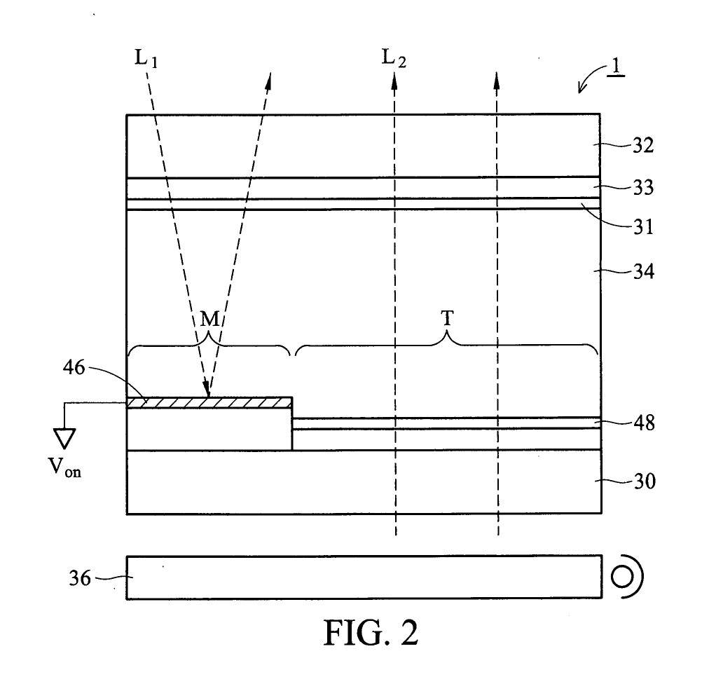

FIG. 2 is a cross section of a mirror LCD panel 1 in accordance with one embodiment of the present invention, wherein M represents a mirror region or a non-transmissive region, and T represents a transmissive region.

As shown in FIG. 2, a liquid crystal layer 34 is interposed between a first substrate 30 and a second substrate 32. A backlight module 36 is disposed under the first substrate 30 to be used as a light source. The first substrate 30 is a thin film transistor substrate, including a plurality of pixels, each of which comprises a mirror region M and a transmissive region T. (FIG. 2 schematically represents only one pixel region.) A mirror electrode layer 46 is disposed in the mirror region M and a transparent electrode 64b is disposed in the transmissive region T, both electrically isolated from each other. The electrodes 46 and 64b are operated independently. In a preferred embodiment, the mirror electrode layer 46 has extraordinary uniform and smooth surface to improve the reflecting effect. Mirror electrodes 46 in adjacent pixels are electrically interconnected. The second substrate 32 is a color filter substrate, comprising a color filter layer 33 and a common electrode layer 31 disposed on the inner side.

When the mirror LCD is in normal white mode (a mode in which the optical transmissibility reaches the maximum when the signal voltage that is provided to the transmissive electrodes for displaying image applied to the liquid crystal is zero), it is powered off with the liquid crystal parallel to the polarization of the polarizer. Ambient light L₁ is reflected at the mirror region M, thus the mirror LCD representing as a mirror, wherein voltage Vₒₙ is not applied to the mirror electrode layer at this moment. The voltage Vₒₙ different from the signal voltage is provided to increase contrast ratio. When the mirror LCD is powered on, light L₂ from backlight module 36 passes the transmissive region T, enabling displaying in accordance with pixel data. Additionally, voltage Vₒₙ can be applied to the mirror region M to control the reflecting rate (or intensity of reflecting light) by twisting the liquid crystal molecules thereon, increasing contrast ratio in display mode. Essentially, by turning on Vₒₙ when the display is turned on, the reflective effect of the mirror electrode layer is suppressed, to increase the contrast ratio of the display.

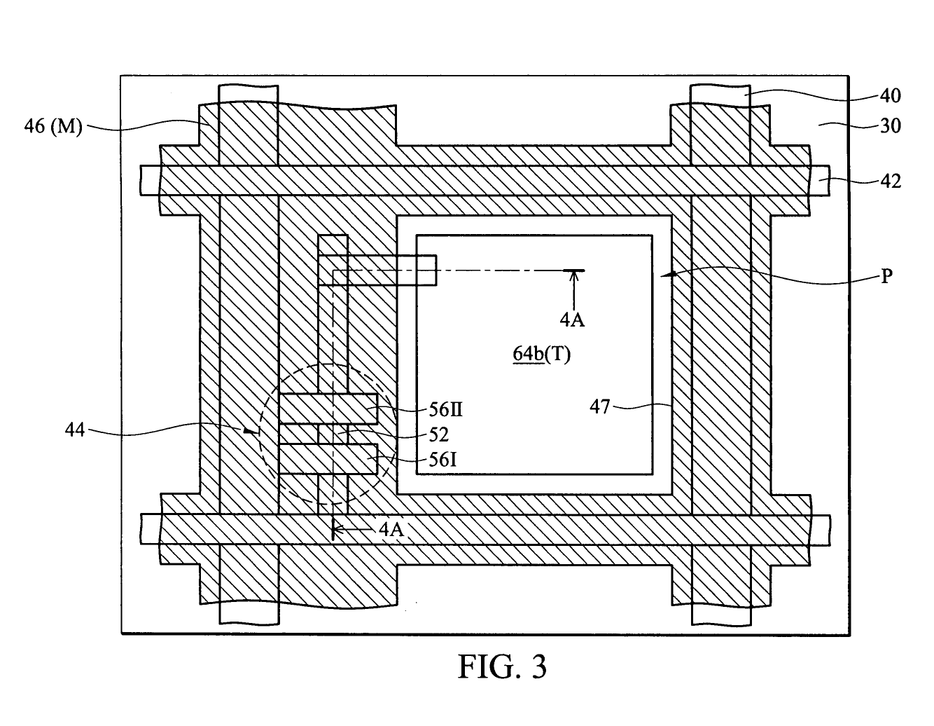

FIG. 3 is a top view of the mirror LCD panel of the present invention. The first substrate 30 comprises a plurality of pixels P, defined by gate lines 40 and data lines 42, perpendicular to each other. Each pixel P has a mirror region M and a transmissive region T. In addition, a thin film transistor (TFT) 44 (which may be low-temperature polysilicon TFT), a mirror electrode layer 46 and a transmissive electrode layer 64b are disposed in each pixel. The TFT can be a single gate TFT or a multi gate TFT. Using the double gate TFT as an example, the mirror electrode layer 46 is formed in the mirror region M, covering the gate line 40, the data line 42, and the TFT 44. The mirror electrode layer 46 of each pixel can be interconnected to form a matrix with a plurality of openings 47. Alternatively, the mirror layer 46 may be in the form of a matrix layer having a plurality of openings 47. The transmissive electrode layer 64b is formed in the transmissive region T. As well, the transmissive electrode layer 64b is disposed in the corresponding opening 47. The mirror electrode layer 46 and the transmissive electrode layer 64b are electrically isolated from each other, and both operate independently. Due to the connection of each mirror electrode layer 46, the mirror electrode layer can receive a voltage Vₒₙ to control the liquid crystals 34 thereon, increasing contrast ratio.

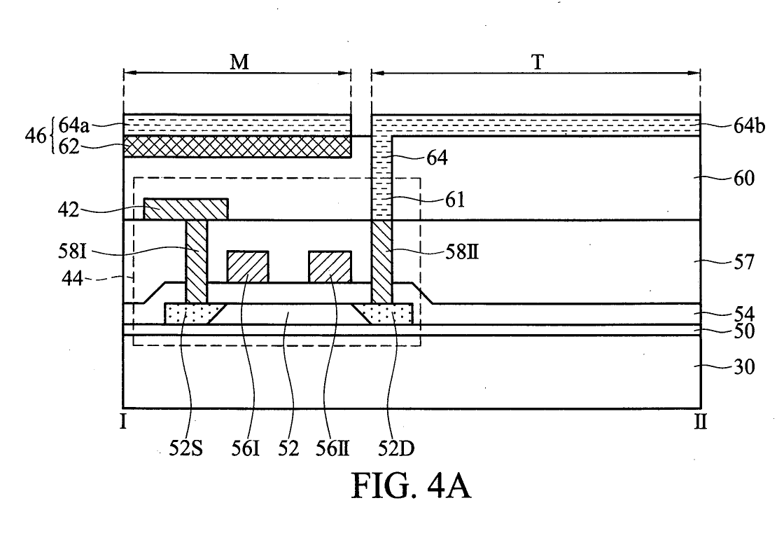

FIG. 4A is a cross section along line 4A-4A of FIG. 3. As shown in FIG. 4A, a buffer layer 50 and an active layer 52 are formed on the first substrate 30, wherein the active layer 52 is disposed in a predetermined region of the TFT 44. Preferably, the first substrate 30 is a transparent substrate or a glass substrate, and the buffer layer 50 is a silicon oxide layer. The buffer layer 50 increases adhesion between the active layer 52 and the first substrate 30. Preferably, the active layer 52 is a semiconductor layer, and more preferably a polysilicon layer, comprising a drain region 52S and a source region 52D. A gate dielectric layer 54 covers the active layer 52 and the buffer layer 50, preferably formed of silicon oxide, silicon nitride, silicon oxide nitride or combinations thereof. A first gate layer 56I and a second gate layer 56II are formed on the gate dielectric layer 54. A first dielectric layer 57 covers the first gate layer 56I, the second gate layer 56II and the gate dielectric layer 54. The first dielectric layer 57 is penetrated by a first and a second plug 58I and 58II, connecting the source region 52S and the drain region 52D respectively. Consequently, the data line 42 can connect the source region 52S through the first plug 58I.

The second dielectric layer 60 is formed on the first dielectric layer 57 and comprises a contact hole 61 to expose the second plug 58II thereunder. A first conductive layer 62 is formed on the second dielectric layer 60 in the mirror region M, covering the TFT 44. Preferably, the first conductive layer 62 may reflect light. A second conductive layer 64 fills the contact hole 61 and comprises a first portion 64a and a second portion 64b that are electrically decoupled. The first portion 64a is formed on the first conductive layer 62 in the mirror region M, and the second portion 64b is formed on the second dielectric layer 60 in the transmissive region T. The second portion 64b is connected to the drain region 52D through the contact hole 61. Preferably, the second conductive layer 64 is formed of transparent materials, such as ITO or IZO. The first conductive layer 62 and the second portion 64a of the second conductive layer 64 in the mirror region M define a mirror electrode layer 46 (as shown in FIG. 2). The second portion 64b of the second conductive layer 64 acts as a transmissive electrode layer 64b (as shown in FIG. 2).

FIG. 4B is a cross section of another embodiment of the invention. The embodiment in FIG. 4B is similar to the one in FIG. 4A. The difference is that only the first conductive layer 62 in the mirror region M defines the mirror electrode layer 46 (as shown in FIG. 2).

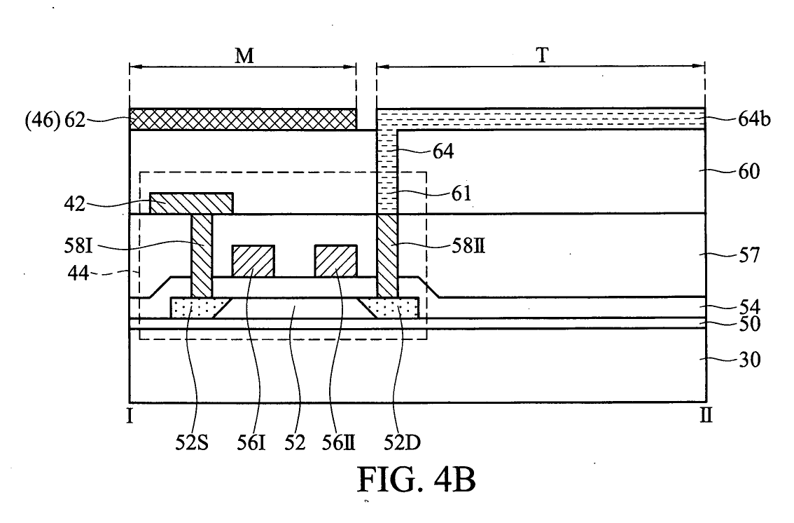

FIG. 5 is a schematic diagram of a display device 3 comprising the mirror LCD panel in accordance with one embodiment of the present invention. The display panel 1 such as that shown in FIG. 2 can be couple to a controller 2, forming a display device 3 as shown in FIG. 4A. The controller 2 can comprise a source and a gate driving circuits (not shown) to control the display panel 1 to render image in accordance with an input. The controller 2 also controls the operations the transmissive electrode and the mirror electrode shown in FIG. 2 and FIG. 4A.

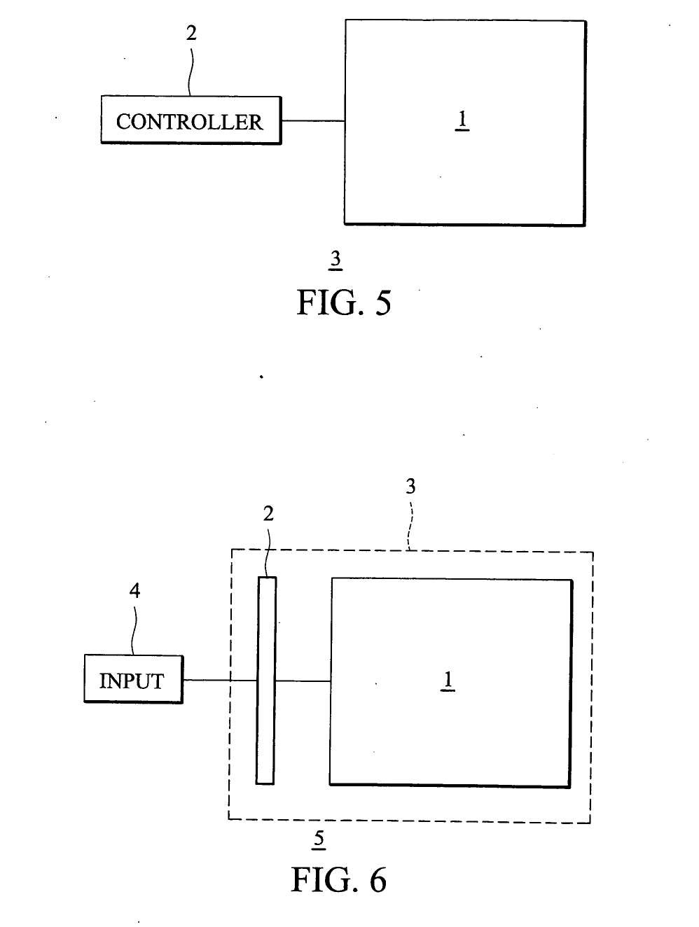

FIG. 6 is a schematic diagram of an electronic device 5, incorporating a display comprising the mirror LCD in accordance with one embodiment of the present invention. An input device 4 is coupled to the controller 2 of the display device 3 shown in FIG. 5 can include a processor or the like to input data to the controller 2 to render an image. The electronic device 5 may be a portable device such as a PDA, notebook computer, tablet computer, cellular phone, or a desktop computer.

Accordingly, the present invention provides a combination of a mirror electrode and a transmissive display. Due to the mirror electrode layer 46 and the transmissive electrode layer 64b disposed in each pixel P, the mirror display can represent as a mirror or display pictures. When displaying pictures, the liquid crystals in the mirror region M can be controlled by the mirror electrode layer 46 to adjust intensity of the reflecting light so as to increase contrast ratio of the displaying image. Furthermore, according to various embodiments, the mirror display of the present invention has another advantage that the thickness of the display is decreased compared to the conventional mirror display. The manufacturing cost is thus reduced.

While the present invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of thee appended claims should be accorded the broadest interpretation so as to encompass all such modifications and similar arrangements.

1. A mirror liquid crystal display, comprising:
a plurality of pixel regions, each of which comprises a transparent region and a non-transparent region;
a plurality of mirror electrode layers, each on the corresponding non-transparent region, with the mirror electrodes interconnected with each other;
a plurality of transmissive electrode layers, each at the corresponding transparent region, with the transmissive electrode layers electrically isolated from the mirror electrode layers; and
a voltage source coupled to the mirror electrode layers to apply a voltage to control liquid crystals over the non-transparent region.

2. The mirror display as claimed in claim 1, wherein the non-transparent region acts as a mirror when voltage is not applied to the mirror electrode.

3. The mirror display as claimed in claim 1, wherein the non-transparent region is a matrix comprising a plurality of openings, and each transparent region is disposed in a corresponding opening.

4. The mirror display as claimed in claim 1, further comprising:
a first substrate, with pixel regions disposed thereon;
a second substrate opposite the first substrate;
a liquid crystal layer interposed between the first substrate and the second substrate;
a color filter layer disposed on an inner side of the second substrate; and
a backlight module disposed on an outer side of the first substrate.

5. The mirror display as claimed in claim 4, wherein voltage applied to the mirror electrode layers controls the liquid crystals over the mirror electrode layers to dominate light reflection of the non-transparent region.

6. The mirror display as claimed in claim 1, wherein the transmissive electrode layers are transparent materials selecting from the group of ITO and IZO.

7. The mirror display as claimed in claim 1, wherein the mirror display is a liquid crystal display or an organic light emitting display.

8. A liquid crystal display, comprising:
a first substrate;
a plurality of gate lines and data lines formed on the first substrate to define a plurality of pixel regions;
a mirror electrode layer covering at least the gate lines and data lines to form a matrix with a plurality of openings;
a plurality of transmissive electrode layers, each formed in a corresponding opening with the mirror electrode layers and the mirror electrode layers isolated from each transmissive electrode layers, wherein the mirror electrode layers defines a mirror region and the transmissive electrode layers defines a transmissive region; and
a voltage source coupled to the mirror electrode layers to apply a voltage to control liquid crystals over the mirror region.

9. The liquid crystal display as claimed in claim 8, wherein the liquid crystal display acts as mirror mode when voltage is not applied to the mirror electrode layers.

10. The liquid crystal display as claimed in claim 8, further comprising a plurality of thin film transistors, each of which is disposed in the corresponding mirror region.

11. The liquid crystal display as claimed in claim 10, wherein the mirror electrode layers cover the thin film transistors.

12. The liquid crystal display as claimed in claim 10, wherein each thin film transistor comprises:
at least a gate layer;
a source region electrically connected to the data line; and
a drain region electrically connected to the transmissive electrode layers.

13. The liquid crystal display as claimed in claim 8, wherein the transmissive electrode layers are formed of transparent materials selecting from the group of ITO and IZO.

14. The liquid crystal display as claimed in claim 8, further comprising:
a second substrate opposite the first substrate;
a liquid crystal layer interposed between the first substrate and the second substrate;
a color filter layer disposed on an inner side of the second substrate; and
a back light module disposed on an outer side of the first substrate.

15. The liquid crystal display as claimed in claim 14, wherein voltage applied to the mirror electrode layers controls the liquid crystals over the mirror electrode layers to dominate light reflection of the non-transparent region.

16. A display device, comprising:
a mirror liquid crystal display as in claim 1; and
a controller coupled to the display panel to control the display panel to render an image in accordance an input.

17. The display device as claimed in claim 16, wherein the non-transparent region is a matrix comprising a plurality of openings, and each transparent region is disposed in a corresponding opening.

18. The display device as claimed in claim 16, wherein the display panel further comprises:
a first substrate, with pixel regions disposed thereon;
a second substrate opposite the first substrate;
a liquid crystal layer interposed between the first substrate and the second substrate;
a color filter layer disposed on an inner side of the second substrate; and
a backlight module disposed on an outer side of the first substrate.

19. An electronic device, comprising:
a display device as in claim 14; and
an input device coupled to the controller of the display device to render an image.

20. The electronic device as claimed in claim 19, wherein the non-transparent region is a matrix comprising a plurality of openings, and each transparent region is disposed in a corresponding opening.
